(19) United States
(12) Patent Application Publication
(10) Pub. No.: US 2008/0021719 A1
(43) Pub. Date: Jan. 24, 2008

(54) METHOD AND SYSTEM FOR UTILIZING COLLECTIVE EDUCATION IN THE WORKPLACE

(76) Inventor: William J. McFaul, Jackson, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/778,966

(22) Filed: Jul. 17, 2007

Related U.S. Application Data
(60) Provisional application No. 60/832,633, filed on Jul. 21, 2006.

(51) Int. Cl. G06Q 10/00

(52) U.S. Cl. 705/1

(57) ABSTRACT

A method and system for using collective education in order to create innovation and efficiency within an organization. The method also enables organizations to create a shared culture so as to facilitate their ability to work together.

This application claims benefit of U.S. Provisional Application No. 60/832,633 filed on Jul. 21, 2006, the entirety of which is incorporated herein by reference.

### BACKGROUND OF THE INVENTION

1. Field of Invention

The invention relates to the management and organization of businesses. In particular, the invention relates to utilizing shared abilities of employees in order to establish a unified culture, improve innovation and facilitate the accomplishment of tasks.

2. Description of Related Technology

Whenever there is an attempt to bring two organizations together to create harmony and collaboration of various operating units within a company, it is inevitable that an array of issues will arise due to conflicting outlooks by the groups. Two organizations will differ in a range of different ways that reflect their underlying cultural differences. It is a daunting task to attempt to influence all of the factors that create these cultural differences and the broad spectrum of personal attributes in efforts to change such cultures. Historically such efforts have rarely worked.

Rather than continue to devote valuable time and effort in a futile effort to change cultures, which in a best case scenario produces only minimal results, the most effective process is to create a common platform of cultural elements that can be mutually supported by all the parties (i.e. create a new overarching culture for the new enterprise). While such a challenge may initially sound difficult, selecting the right implementation team may be achieved by using a variety of tools.

Furthermore, today's healthcare and financial organizations have business and geo-political environments that demand optimally efficient planning and decision support processes for all activities. Unfortunately, due to time constraints and the plethora of often conflicting and confusing cross-cultural communication and management theories, cultures within organizations rarely have the opportunity to carefully analyze the array of options available to meet their specific needs and adapt them appropriately. As a result, current methods of communication fail to be able to develop and deploy optimal modeling processes to meet today's highly unique situations.

Therefore there remains a need in the field for providing an effective method and system to establish shared cultural values, goals for an organization, and improved knowledge and skill sets.

### SUMMARY OF THE INVENTION

An aspect of the present invention can be a method for using a collective educational system comprising: establishing an internal consulting group comprising a plurality of members for at least one organization; providing an instructor for said internal consulting group; providing information for each member of said internal consulting group; establishing a shared interpretation of said information; and using said shared interpretation in order to alter a manner in which said organization operates.

Another aspect of the present invention can be a collective educational system comprising at least one organization; a plurality of members selected to form an internal consulting group; an instructor; a network connecting said plurality of members enabling communication and collaborative learning.

Yet another aspect of the invention can be a method for using a collective educational system comprising establishing an internal consulting group comprising members from a plurality of organizations, providing an instructor for said internal consulting group; providing information for each member of said internal consulting group; receiving interpretations of the information from each of the members; combining the interpretations to form a shared interpretation using said shared interpretation in order to alter a manner in which said organization operates; and updating said information periodically.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows an example of the information, sills, knowledge topics and subjects that may be pursued by an organization.

FIG. 2 is a flow chart illustrating the steps used in the collective educational system.

FIG. 3 shows a sample test used for an operations director.

FIG. 4 is a diagram of the collective educational system.

### DETAILED DESCRIPTION OF THE INVENTION

By using a variety of tools an organization can effectively form a group that can restructure the organization in order to establish a unified culture. Alternatively two or more disparate organizations can also form a group so as to establish an effective unified culture. Furthermore, this group can be utilized in order to facilitate problem solving and fostering innovation in a variety of areas. Tools such as mental functioning activity and the analysis of characteristics, skills and knowledge of individuals can be used in conjunction with criteria established by the organization in order to establish groups.

These leadership groups, called internal consulting groups, can accomplish the goals of establishing a unified culture. An internal consulting group adheres to organizational guidelines put forth by the governing body. These guidelines ideally offer minimum specifications and restriction and have a strong focus on the desired objective. The internal consulting group can accomplish the organization's needed tasks and/or create and oversee a separate “implementation team” to execute the creation of the variety of phrases discussed below. The internal consulting group can also be used for collectively educating the group through a shared learning process.

The collective education system and method, or shared learning process provides a forum for the presentation of different perspectives (base knowledge, skills and expertise) from all members of the internal consulting group (ICG). This provides for the interpretation of various philosophies and theories which might influence the current and future needs of the new culture. The value of the collective education method is to function as the engine to recognize, evaluate and drive the identification and evaluation of viable alternatives.

The collective education system and method is designed for use with two or more persons in a group, team or committee setting, that grants the members of the group access to education, training and information pertaining to all aspects of a specified task, role, function, or purpose for which the members were gathered. This process allows members to share, maintain, and grow the acquired skills and knowledge thereby enabling the members to deliver optimal results that pertain to their specified task, role, function, or purpose.

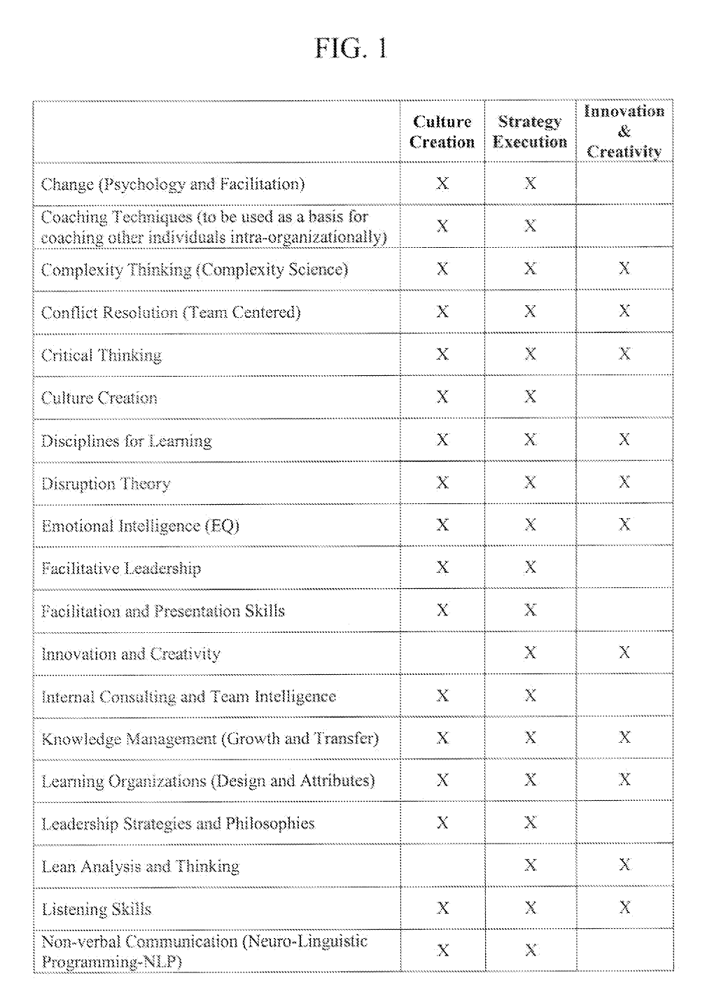

Before the collective education method can begin, the appropriate skills and knowledge must be selected and evaluated for each person who is to become a member of the internal consulting group. FIG. 1 shows an example of some of the information, skills, knowledge, topics and subjects that may be selected for different purposes and that may be pursued by an organization in order to achieve culture creation, strategy execution, innovation and creativity. The items selected for each category correspond to the needed skills and knowledge as they are related to the purpose. These items can be compared to that of a syllabus used to itemize the various subjects taught in educational settings. Once these topics are selected, the evaluation process for these skill and knowledge sets can begin. These items shall be referred to as subject(s) or subject matter.

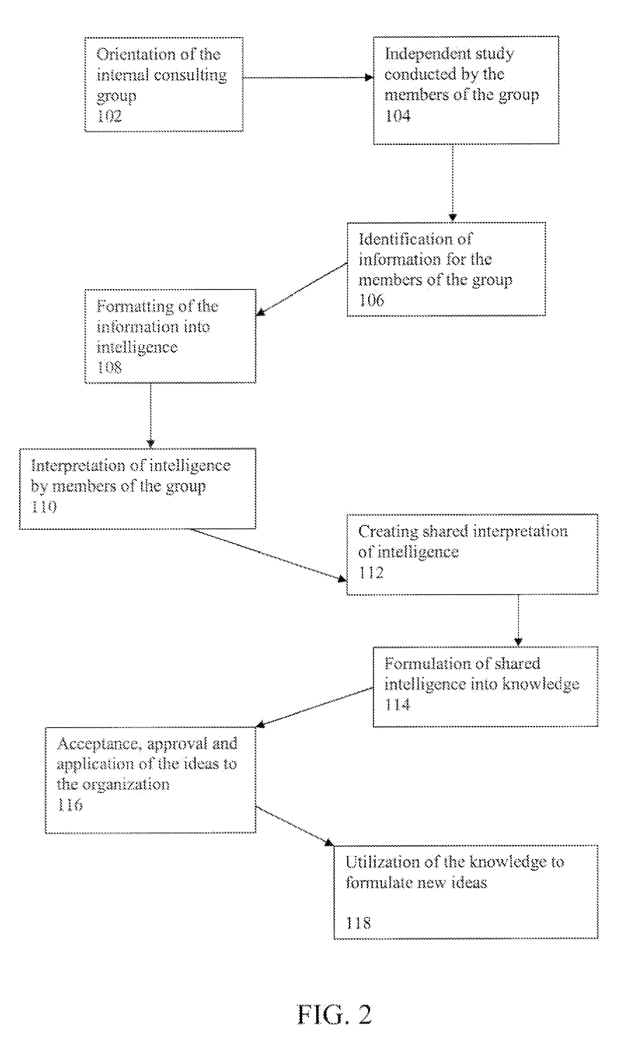

The collective education method involves the steps shown in FIG. 2. The first step in the collective education method assumes that a group of two or more people has already been formed. The group may be assembled or already exist within an organization. This group may or may not have a specific objective, function or purpose. In order to create a group that is better adapted for the collective education, the group should be created using evaluation tests for the characteristics, skills and knowledge of the would be members of the group. A persons mental functioning activity (MFA) may also be evaluated in order to select the proper members of the group.

IN general, the specific knowledge, skills and characteristics needed for a given position are ascertained by the organization. Tests and/or questionnaires are provided either electronically or in paper form to the individuals who are to become members of the group. As part of the testing process, personality tests may also be given in order to help determine what a person's characteristics are. It is also possible to determine a person's MFA.

After the tests are administered the necessary groups can be formed of those members who meet the desired criteria set out previously and/or those who may best function together. Smaller groups of two or more may utilize the collective education method for taking on less complicated task, or objectives. Large internal consulting groups can use the collective education method for such complex purposes as culture creation, strategy execution, likely evolution, and creativity and innovation.

An example of what the ICG can be used for is to develop a shared vision for an organization. Typically when companies merge, participants in the planning process often struggle to establish a strategic vision which provide an overarching statement summarizing the ideal direction the parties should take. Historic differences and the ideology of the individual leaders of the respective parties often prevent effective collaboration between or within organizations.

The seed for collaboration must come from interfacing all necessary cultures while protecting their individual core ideologies without demeaning the core ideologies of the other cultures. While this critical phase of the culture creation process may be difficult, it can be accomplished by the collaborative efforts of a multi-cultural cross-functional team such as the ICG.

Another use of the ICG is for creating corporate change. Rarely do organizations recognize that their failed efforts to build intra-organizational collaboration care attributable to cultural differences. Interdepartmental or corporate politics and the creation of “silos” are, in fact, clashes between different cultures within the organization. Accordingly, until such cultural differences are addressed, the chances for meaningful, long term harmony and intra-organizational collaboration are minimal.

Another use of the ICG is for providing a shared fate. The shared fate transcends the mere preparation of a statement for culture-wide or cross-cultural dissemination. Rarely have organizations provided a core group of their mid-level leaders/managers with the authority and support to create processes to execute strategic changes required for establishing a new culture. Unlike historic approaches for attempting to modify current attitudes, opinions and differences, the process of culture creation necessitate the delineation of all deficiencies, obstacles and weakness which impact an organization's ability to implement change. By working together with the guidance of unbiased third part facilitator(s), the implementation team can create internally prepared action plans to create new mechanisms or processes which address all of the issues to the satisfaction of all organizations. This planning/problem identification process is the creation of a value proposition. The task of identifying what points or factors offer each organization the features or outcomes that deliver all parties the necessary “wins”. The outcome of this exercise is the identification of WIIFMs (What's In It For Me) that each organization recognizes as being powerful enough to get their members to be willing to accept behavioral change/modification—while acknowledging and respecting the need for the other (cultures) to obtain their WIIFMs without sacrificing their own core ideologies.

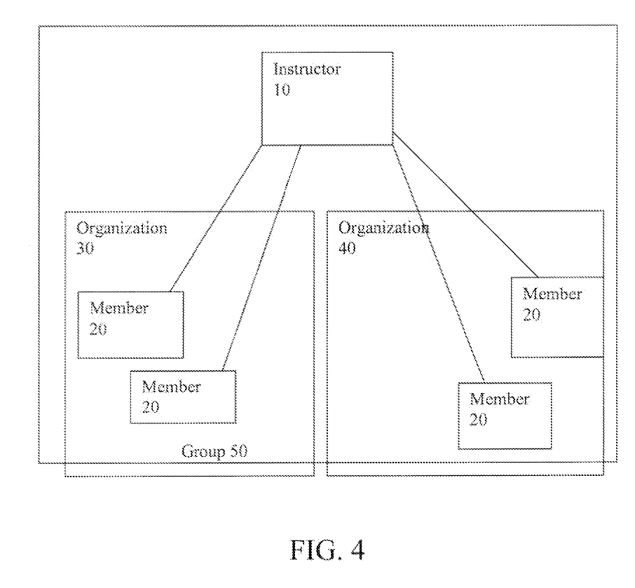

FIG. 2 illustrates the steps used in the collective education method and system. FIG. 4 shows a diagram of the collective education system and is referred to in the discussion of the method. Referring to FIG. 2, At step 102, an orientation session is provided for the group 50. The members 20 of the group 50 may be provided by a first organization 30 and a second organization 40. However the method may also be performed when the members 20 all come from within the same organization. The orientation session is preferably administered by an instructor 10. The instructor 10 may inform the members 20 of the first group to carefully interpret all material presented, studied, or discussed from the aspect of their particular specified task, role, function, or purpose within the group 50. Each of the members 20 may be equipped so as to communicate with each via computers over a network.

The orientation session performed in step 102 should include a broad overview of the subject matter, the various topics which will be addressed in forthcoming sessions, and an explanation of how this material will apply specifically to the objectives of the members 20 individually and as a whole to meet their objectives. The members of the group 50 may meet locally or utilize computer networks in order to conduct operations over long distances.

Prior to initiating the collective education process it is preferable that the group 50 is balanced through the use of the preliminary screening tests such as CSK (characteristics, skills, and knowledge) tests and MFA and/or personality test analyses, the group 50 will have already been formed prior to initiating the concept. The members 20 will already understand their role in meeting the specific objective of the group 50. These members 20 can therefore focus their education and training on how to apply their acquired skills and knowledge in order to execute their particular role and to interpret the intelligence they gain as it will interface with and apply to the assigned objective of the group 50 as a whole.

MFA is a term used to illustrate a spectrum of possible mental and behavioral characteristics correlated with their actual or categorized brain activity. For example some characteristics that make up MFA are focus, over-focus such as obsession, awareness and disinterest, temperament such as rage, anger, aversion, and disenfranchisement; concern, such as fright, fear, sadness and despair; happiness, such as resentment, bitterness, joy, envy and avoidance, and physical behavior, such as overly-active, active, lethargic and sedentary. MFA provides a gauge that helps ascertain a personal's ability to dedicate greater or lesser focus on tasks and their ability to handle tasks. Furthermore, the various bands of thought process discussed above may have specific MFA levels attributed to them, and the MFA of the different bands of thought assessed individually.

In general, MFA is more intimately related to the physical functioning of the brain and may be further visualized using magnetic resonance imaging or other physical diagnostic tools. However, in the event that the usage of physical imaging cannot be used, it is possible to use specially formatted questionnaires in order to gauge the level of a persona's MFA.

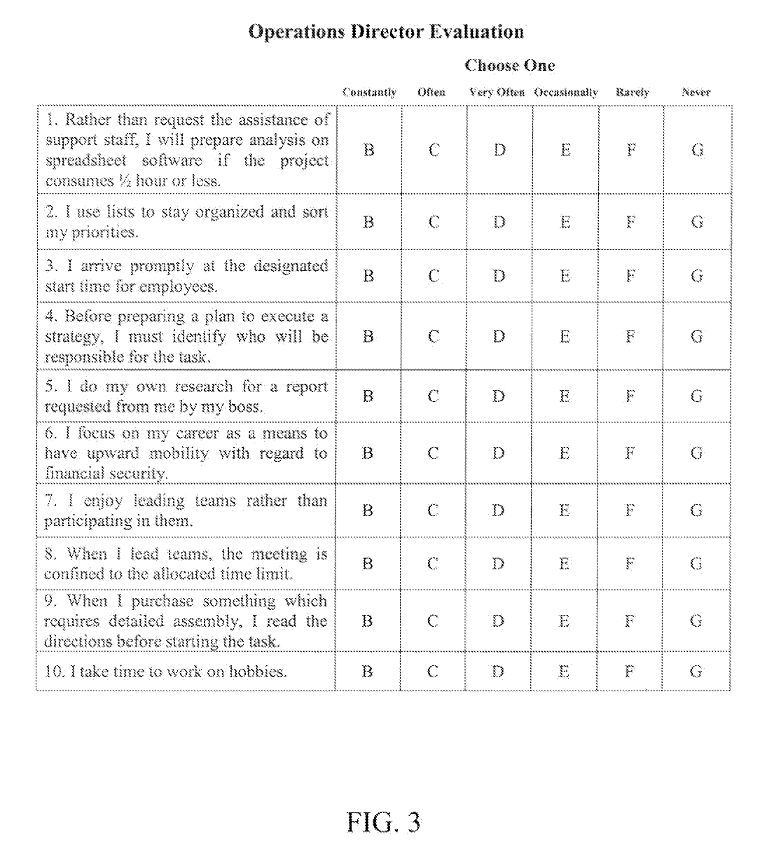

At example questionnaire that may be used to determine MFA, is found in FIG. 3. The example questionnaire is a sample test used to evaluate the MFA for an operation director. This test is a customized example of a general test that may be used in a generic business setting. The questions may be selected from a “master” worksheet, or a database of acceptable questions that are designed to illicit appropriate gauging of MFA. Alternatively, the questions may be developed specifically for the sought after position.

Upon being tested a person may be given a categorization number such as 10-11-12-1-2-3, as a result of completing the test. These numbers are based upon positions of a clock. For example, under the topic of “leadership,” an individual selecting “collaboration” as their most likely assumed “role” as it relates to that topic would fall into the “12” category. This based upon a pre-determined assignment of “position” for various characteristics. It should be understood that the actual categories into which people placed is arbitrary. The sample test questions found in FIG. 3 have a customized sampling of topics chosen for relatedness to the requirements of the position.

The preliminary screening test may alternatively, or in addition to the MFA test, use CSK sets (characteristics, skills, and knowledge sets) in order to provide an initial evaluation that considers multiple factors of people. One of the factors used is the characteristic set (C Set) of an individual. The characteristics of an individual are those traits that govern how an individual will act in certain environments, indeed it may focus upon an individual's MFA as discussed above. An individual's skill set (S Set) is the second additional factor used in this method and system. An individual's S set are those traits that can be acquired through schooling or acquired through on the job training. An individual's knowledge is the third factor used in this approach. An individual' knowledge set (K Set) is an element verificable through proven accomplishments. Both skills and knowledge are essential considerations in evaluating a person's qualifications. However since skills and knowledge can be developed, i.e. acquired or learned, they serve to compliment a person's characteristics. The determination of a person's CSK set assists in formation of the group 50.

After the initial screening and selection of the members 20 for the group 50, the instructor 10 should familiarize the members 20 with all of the necessary educational and training material and provide an estimated timeline for the completion of all individual assignments as well as the completion of and the education and training associated with the subject matter. Distribution of reference and instructional material will be at the discretion of instructor 10. However, as part of the orientation session, instructor 10 may also provide members 20 with several articles or other background documents which clearly indicate the benefits and potential of applying the newly acquired skills and knowledge to the objectives of their task, role, or occupation. Such documents could, at the discretion of instructor 10, be assigned as homework and used to initiate discussions at the next session regarding the value of the subject matter and its applicability to the objectives of members 20 or, if applicable, to a group, team, or committee. The administration of the training and education may be performed by more than one instructor 10, base on specialty and or expertise in certain subjects.

Each member 20 of the group 50 in this process will have been selected based on their willingness to participate and, as such, will have made a commitment to devote the necessary time and energy to complete the full course of training and education while keeping with the previously designated objective of the process. At step 104, each member 20 of the group 50 will have completed an independent study of the material. By the end of the sessions each subject within the material identified in the skills and knowledge sets for the concept should have been covered. Each member 20 will have been required to study the certain aspects of individual subjects and all of the topics which contribute to its application. To accomplish this task, the instructor 10 for each subject provides members 20 with all of the necessary instructional material associated with the subject as a whole as well as each sub-topic which contributes to the understanding and ability to apply the subject in such a way as designated as part of the objective collective education method and system. As part of step 104, the members 20 conduct independent study for each subject as divided by the instructor 10 into all of the major sub-topics encompassed within it. For example, the subject of team building would be sub-divided into individual roles, establishing behavioral norms, conflict resolution, brainstorming techniques, meeting management, etc. As part of step 104, the members 20 should attempt to interpret information provided as a starting point for the establishment of a foundation of their skills or knowledge as it can apply to their particular task, role, or occupation.

At step 106 each member 20 searches for an identifies all pieces of new information within each topic which may be useful in having them perform their task, role, or occupation more effectively or efficiently. The instructor(s) 10 will facilitate discussions with the group 50 in order to share the new information in order to gain insight into the applicability of the information as it is perceived by others as being applicable to their needs and objectives. The purpose of these topic-by-topic information gathering sessions for each subject is for the members 20 to gain a broad understanding of how individual issues and information can be viewed as being valuable pieces for potential use in order to create comprehensive solutions as opposed to mere incremental changes of enhancements based on the views or opinions of only a select few individuals.

At step 10, the members 20 assemble in order to share their individual views and opinions and attempt to establish a collective knowledge on the subject as a whole. As part of this phase, each member 20 should attempt to interpret and share the knowledge and insight gained through the collaborative sharing of respective views, perspectives and interpretations of the other participants as it pertains to their respective task, role, or occupation. This joint process is intended to identify previously unrecognized possibilities or opportunities by combining various elements of information and converting it into intelligence which pertains to the subject matter (i.e., in this sense, intelligence refers to the type of collective acumen that can be built by combining various elements of information).

At step 110 interpretation of the gathered intelligence is performed. At this step the members 20 separate in order to independently review and reflect upon all of the newly acquired and created intelligence. This independent review is designed to allow the members 20 adequate time to analyze how the newly created intelligence may affect their task, role, or occupation as well as its possible impact on the object of the collective education method and system. At this step, each subject is addressed as part of the collective education concept. The instructor 10 should also remind the members 20 that the objective of the collective education method and system was established in the introductory phase. Accordingly, depending upon that objective, the members 20 may be required to repeat the aforementioned process for numerous subjects in order to establish a foundation of skills and knowledge from which they can build optimal solutions for assigned tasks or objectives.

At step 112, a shared interpretation of the intelligence is created. The collective education method is used to build a foundation of skills and knowledge (as opposed to addressing a single subject), the members 20 should reconvene after completing interpretation of the intelligence phase on a subject-by-subject basis. The instructor(s) 10 can organize the collective education method in such a way so as to insure that the subjects are studied in a linear fashion (i.e., the subject acts as a prerequisite for the next. For example, prior to addressing time management, the members 20 should receive education and training in listening skills as well as topics pertaining to when and how to learn, study, and interpret information optimally. The instructor(s) 10 should ensure that the members 20 interface all of the knowledge they accumulated to date (i.e. from interfacing the knowledge gained from combining the intelligence from the first and second subject, from the first through the third subject, etc.). The members 20 must revisit the accumulated base of expertise and update it as it pertains to their individual tasks, roles, or occupations as well as its applicability to the objective of the collective education method as a whole following the completion of the education and training of each of the designated subjects.

Upon reconvening, the members 20 of the group 50 may document specific intelligence they gained as it pertains to possible alternatives as to how material within the subject are handled and how the learning itself is handled. The instructor(s) 10 may utilize this intelligence to enhance the education and training materials to be utilized for subsequent collective education programs.

This process of using collaboration to build upon or enhance state-of-the-art practices or theories on a subject-by-subject basis to the point when they can be interfaced to contribute to the creation of the next iteration of a process, task, or objective is critical to ensure organizations build, maintain, and grow intellectual capital in order to ensure the optimal execution of strategies.

Step 114, involves the collective discussion and interpretation of all aspects of all subjects (including all topics and issues) to create “new” skill and knowledge sets for the members 20 of the group 50 individually and, when applicable to the group 50 as a whole. Following the use of the collective education method with each subject, the members 20 are prepared to address their assigned objective by using their new collective skill and knowledge sets. They will have gained the collective acumen to create solution or options capable of meeting the individual needs of all of the members 20, their group 50, or the organization as a whole. By having worked cohesively to form a collective base of knowledge, the members 20 gain the ability to study and interpret the needs and perspectives of their peers. Accordingly, when the objective of the process is to establish a team process, the members 20 will already know and understand the core needs and objectives of each of their fellow members 20. This element of the process will be an important factor for ensuring that the group 50 functions in a highly effective manner.

In step 116, the learned results from the collective education method are applied to the specified tasks or goal for which they were striving. The final step in the process is the point when the members 20 use the collective knowledge and skills acquired as a result of the collective education method as they relate to all aspects of a specified task, role, function, or purpose for which the members 20 were assembled. The members 20 may be assigned multiple topics for monitoring and research on an ongoing basis. Ideally, the assigned topics should be rotated bet ween the members 20 on an annual basis.

In step 118, the results obtained through the collective education method are capitalized upon in order to continue the overall learning process, while maintaining the continued development of the learning process. While the members 20 will gain the knowledge to create optimal solutions through empowerment by the leadership, they must remain committed to the constant maintenance of the new process by revisiting the entire process on an ongoing or predetermined schedule. This knowledge growth process can be assigned to a minimum of two members 20 per subject to research the subject and all associated sub-topics and issues on an ongoing basis in order to determine when additions or enhancements to the then current state-of-the-art knowledge (based on the outcome of the collective education method and system) should be updated. While any member 20 may identify new information which should be injected into the process, any such new information should be directed to members 20 who are responsible for that category of information. Then, depending upon the protocols established at the conclusion of the collective education method, the assigned members 20 should circulate or present this new information to the other members 20 on an ongoing basis or a predetermined schedule. In instances where the members 20 do not interface as a group 50 on an ongoing basis, this sharing of information can continue on a community of practice or community of interest basis. In these instances, although the participants may not communicate on a regular basis, they should be encourage to remain in contact with the members 20 assigned to separate topics for use as resources when needed. In group configurations, the members 20 will have adequate training to ascertain whether or not the information warrants review and analysis by their respective unit with the understanding that it could be parlayed into new intelligence and used to enhance the collective knowledge of group 30.

Regardless of whether or not the sharing of new “information” is distributed through processes such as communities of practice or through formal group processes; the instructor(s) 10 and the members 20 are responsible for the formation and governance of the collective education method should receive all such additions and updates. The members 20 must then make a determination regarding the efficacy of the new information and whether or not it should be included in subsequent collective education method.

It is to be understood, however, that even though numerous characteristics and advantages of the present invention have been set forth in the foregoing description, together with details of the function of the invention, the disclosure is illustrative only, and changes may be made in detail within the principles of the invention to the full extent indicated by the broad general meaning of the terms in which the appended claims are expressed.

What is claimed is:

1. A method for using a collective educational system comprising:
establishing an internal consulting group comprising a plurality of members for at least one organization;
providing an instructor for said internal consulting group;
providing information for each member of said internal consulting group;
establishing a shared interpretation of said information; and
using said shared interpretation in order to alter a manner in which said organization operates.

2. The method of claim 1, wherein said internal consulting group is formed using predetermined skills and knowledge criteria.

3. The method of claim 2, wherein said internal consulting group is formed further using predetermined characteristics.

4. The method of claim 3, wherein said internal consulting group is formed further using mental functioning activity.

5. A collective educational system comprising:
at least one organization;
a plurality of members selected to form an internal consulting group;
an instructor; and
a network connecting said plurality of members enabling communication and collaborative learning.

6. The system of claim 5, wherein said plurality of members are selected from more than one organization.

7. The system of claim 5, wherein said internal consulting group is formed using predetermined skills and knowledge criteria.

8. The method of claim 5, wherein said internal consulting group is formed further using predetermined characteristics.

9. The method of claim 5, wherein said internal consulting group is formed further using mental functioning activity.

10. A method for using a collective educational system comprising:
establishing an internal consulting group comprising members from a plurality of organizations;
providing an instructor for said internal consulting group;
providing information for each member of said internal consulting group;
receiving interpretations of the information from each of the members;
combining the interpretations to form a shared interpretation using said shared interpretation in order to alter a manner in which said organization operates; and
updating said information periodically.

11. The method of claim 10, wherein said internal consulting group is formed using predetermined skills and knowledge criteria.

12. The method of claim 11, wherein said internal consulting group is formed further using predetermined characteristics.

13. The method of claim 12, wherein said internal consulting group is formed further using mental functioning activity.
